(19) United States
(12) Patent Application Publication
(10) Pub. No.: US 2025/0356399 A1
(43) Pub. Date: Nov. 20, 2025

(54) CROWD-SOURCED VENUE RECOMMENDATION SYSTEM AND METHOD THEREOF

(71) Applicant: JLaSalle Enterprises LLC, Bellmore, NY (US)

(72) Inventor: James C. LaSalle, Bellmore, NY (US)

(21) Appl. No.: 19/207,689

(22) Filed: May 14, 2025

Related U.S. Application Data
(60) Provisional application No. 63/647,152, filed on May 14, 2024.

(51) Int. Cl. G06Q 30/0282; G06Q 30/0601; G06Q 50/12

(52) U.S. Cl. CPC G06Q 30/0282; G06Q 30/0631; G06Q 30/0639; G06Q 30/0641; G06Q 50/12

(57) ABSTRACT

The present disclosure relates to a crowd-sourced venue recommendation system and method thereof. The system includes a local software application executing on a mobile terminal (e.g., a smart phone or a tablet) of a user. The system generates a user interface that allows a user to identify variables for selecting a venue, e.g., a restaurant, bar, hotel, pub, nightclub, etc. The system and method of the present disclosure then recommends a venue to the user based on the selected preferences. The system and method then enables the user to provide feedback in relation to a selected venue to feed an AI model to increase the accuracy of the recommendations based on the user selected preferences. The retraining of the AI model of the system utilizes feedback data provided by the user, crowdsourced training feedback data and/or data from various Internet sources which enables rapid data gathering.

### PRIORITY

This application claims priority to U.S. Provisional Patent Application Ser. No. 63/647,152 filed May 14, 2024, the contents of which are hereby incorporated by reference in its entirety.

### BACKGROUND

### Field

The present disclosure relates generally to computer-implemented systems and methods for generating personalized venue recommendations using artificial intelligence. More specifically, the present disclosure relates to dynamic, feedback-based machine learning models deployed in networked computing environments to enhance recommendation accuracy over time and to a crowd-sourced venue recommendation system with Artificial Intelligence (AI) enhanced recommendations and method thereof.

### Description of the Related Art

Recommendation systems, while providing personalized suggestions, grapple with several challenges. One significant issue is the filter bubble, where users are confined to content reinforcing existing limited preferences, potentially limiting exposure to diverse perspectives and information. The cold start problem poses another hurdle, particularly for new users or items with scant historical data, hindering accurate recommendations until sufficient user interactions are recorded.

Conventional venue recommendation systems often rely on static databases or rule-based heuristics that fail to adapt to user feedback in real-time. These approaches do not effectively leverage modern AI techniques for continuous learning and personalization and may result in increased latency, suboptimal user satisfaction, or inefficient use of computing resources.

Therefore, there is a need for systems and methods which can improve the training of recommendation systems via a locally-executing application that can also provide for crowdsourced feedback relating to venues visited by users. Additionally, there is a need for a computer-implemented system that utilizes machine learning models capable of being dynamically updated based on user interaction, improving recommendation precision while operating within resource-constrained mobile or cloud-based environments. These and other needs are addressed by the systems and methods of the present disclosure.

### SUMMARY

The present disclosure relates to a crowd-sourced venue recommendation system and method thereof. The system includes a local software application executing on a mobile terminal (e.g., a smart phone, wearable device or a tablet) of a user. The system generates a user interface that allows a user to identify variables for selecting a venue, e.g., a restaurant, bar, hotel, pub, nightclub, etc. The system and method of the present disclosure then recommends a venue to the user based on the selected preferences. The system and method then enables the user to provide feedback in relation to a selected venue to feed an artificial intelligence (AI) model to increase the accuracy of the recommendations based on the user selected preferences. The retraining of the AI model of the system utilizes feedback data provided by the user, crowdsourced training feedback data and/or data from various Internet sources which enables rapid data gathering.

The present disclosure provides a technical solution to the problem of inflexible and inefficient recommendation systems by leveraging a trained machine learning model within a computing environment. The model is adapted using real-time user feedback and incremental learning techniques to improve recommendation accuracy without requiring full retraining.

The system is implemented using a computing device (such as a smartphone or web server) that includes a processor, memory, and a graphical user interface (GUI) for receiving input and displaying recommendations. Feedback received via the GUI is used to update the model using lightweight learning algorithms suitable for deployment on both client-side and server-side devices.

According to one aspect of the present disclosure, a method for recommending a venue to a user is provided including receiving a type of venue selection; receiving at least one preference related to the selected type of venue; providing, via an artificial intelligence model, at least one recommendation of a venue based on the selected type of venue and preference; receiving feedback on the selected preferences of the recommended venue; and providing the feedback to the artificial intelligence model to improve an accuracy of a subsequent recommendation.

In one aspect, the receiving feedback includes receiving crowd-sourced feedback from a plurality of users.

In another aspect, the receiving feedback includes prompting a user for the feedback when at the recommended venue.

In a further aspect, the receiving feedback includes determining that the user is located at the recommended venue and prompting the user for the feedback when at the recommended venue.

In another aspect, the method further includes prompting at least one second user for feedback in real-time when the at least one second user is at a predetermined venue.

In one aspect, the prompting is generated on a user interface of a mobile device.

In another aspect, the type of venue includes at least one of a restaurant, a bar, a pub, a night club, and/or an adult cabaret.

In a further aspect, the at least one preference related to the selected type of venue includes a location, specials offered, venue setting, music played at venue, crowd age range, preferred attire and/or atmosphere.

According to another aspect of the present disclosure, a user interface for recommending a venue to a user is provided including means for receiving a type of venue selection; means for receiving at least one preference related to the selected type of venue; means for providing, via an artificial intelligence model, at least one recommendation of a venue based on the selected type of venue and preference; means for receiving feedback on the selected preferences of the recommended venue; and means for providing the feedback to the artificial intelligence model to improve an accuracy of a subsequent recommendation.

In one aspect, the user interface further includes means for determining that the user is located at the recommended venue and means for prompting the user for the feedback in real-time when at the recommended venue.

In another aspect, the type of venue includes at least one of a restaurant, a bar, a pub, a night club, and/or an adult cabaret.

In a further aspect of the user interface, the at least one preference related to the selected type of venue includes a location, specials offered, venue setting, music played at venue, crowd age range, preferred attire and/or atmosphere.

According to a further aspect of the present disclosure, a system for recommending a venue to a user includes at least one processing device configured for: receiving a type of venue selection from a mobile device over a network; receiving at least one preference related to the selected type of venue from the mobile device; generating at least one recommendation of a venue based on the selected type of venue and preference, via an artificial intelligence model, and transmitting the recommendation to the mobile device; receiving, from the mobile device, feedback on the selected preferences of the recommended venue; and providing the feedback to the artificial intelligence model to improve an accuracy of a subsequent recommendation.

In one aspect, the system further includes a plurality of mobile devices, wherein each mobile device provides feedback to create crowd-sourced feedback.

In still another aspect of the system, the mobile device includes means for determining that the user is located at the recommended venue and means for prompting the user for the feedback when at the recommended venue.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a diagram illustrating components of a system of the present disclosure;

FIG. 2A is a diagram illustrating hardware and software components capable of being utilized to implement an embodiment of the machine learning system of the present disclosure;

FIG. 2B is a diagram illustrating hardware and software components capable of being utilized to implement an embodiment of a mobile device of the present disclosure;

FIG. 3 is a flowchart illustrating overall processing steps carried out by a system of the present disclosure;

FIG. 4 is a flowchart illustrating overall a method for selecting user preferences in accordance with an embodiment of the present disclosure;

FIG. 5 is a flowchart illustrating overall a method for selecting venue owner settings in accordance with an embodiment of the present disclosure;

FIG. 6 is a flowchart illustrating overall a method for collecting crowd-sourced data in accordance with an embodiment of the present disclosure;

FIG. 7 is a diagram illustrating hardware and software components capable of being utilized to implement the system of the present disclosure;

FIG. 8 is a screen shot of an introduction graphic user interface (GUI) in accordance with an embodiment of the present disclosure; and

FIGS. 9-16 are screenshots of a graphic user interface (GUI) illustrating operation of a mobile software application in accordance with an embodiment of the present disclosure.

It should be understood that the drawings are for purposes of illustrating the concepts of the disclosure and are not necessarily the only possible configuration for illustrating the disclosure.

### DETAILED DESCRIPTION

Preferred embodiments of the present disclosure will be described hereinbelow with reference to the accompanying drawings. In the following description, well-known functions or constructions are not described in detail to avoid obscuring the present disclosure in unnecessary detail. Herein, the phrase “coupled” is defined to mean directly connected to or indirectly connected with through one or more intermediate components. Such intermediate components may include both hardware and software based components.

The system and method of the present disclosure improves venue recommendation systems by crowdsourcing feedback data about a particular venue to reduce the time to populate data about a venue and by employing artificial intelligence (AI) to improve the accuracy of recommendations based on a user's historical preferences. The system includes a local software application, e.g., a mobile app, executing on a mobile terminal or device (e.g., a smart phone, wearable device such as a smartwatch or a tablet) of a user. The system generates a graphic user interface (GUI) that allows a user to identify preferences of variables for selecting a venue, e.g., a restaurant, bar, hotel, pub, nightclub, etc. The system and method of the present disclosure then recommends a venue to the user based on the selected preferences. The system and method then enables the user to provide feedback in relation to a selected venue to feed an AI model to increase the accuracy of the recommendations based on the user selected preferences. The retraining of the AI model of the system utilizes feedback data provided by the user, crowdsourced training feedback data and/or data from various Internet sources which enables rapid data gathering.

Users can mark places as a “Favorite” and when in other areas (e.g., in another city, state, country, etc.) find something similar to their favorites, or find a match to one of their preferences. When in other cities or areas, the device and method of the present disclosure will be able to determine a user's location and use their saved preferences/favorites to find similar types of places and be recommended places based on previous activity in the user's determined location. The mobile app will have AI functionality to make suggestions of similar places based on saved preferences and favorites to Users as adoption grows. By using crowdsourcing data from users, the mobile app will become smarter as more people use it and more venues organize their information appropriately.

The system and method of the present disclosure allow for the filtering of venues to exactly what a user is looking for, and, the ability to apply those preferences in other areas, or find similar venues to ones earmarked as current favorite venues. Advantageously, the system and method of the present disclosure overcome at least the problems of: not knowing where to go in unfamiliar areas, not knowing if you are dressed appropriately, not knowing where there is live music, not knowing what places are similar to your favorite locations, not knowing how crowed or busy a place is at specific times or the day or week. When out of town or even local, but not quite near home and having nothing to do, there is no way to know What's Good on a Tuesday at 3 pm, as an example.

The system is operable in a distributed computing environment, such as a mobile device communicating with a cloud-based recommendation engine. The use of an adaptive model enables continuous learning without requiring complete retraining, improving response accuracy and system performance over time. The present disclosure addresses technical challenges associated with latency, model drift, and resource constraints in AI-driven recommendation systems.

The system comprises a non-transitory computer-readable medium storing instructions which, when executed by a processor, cause the system to receive user inputs via a graphical interface, process venue preferences, and generate recommendations using a neural network or decision-tree-based model. The model may be hosted on a remote server or locally on a mobile device, depending on system configuration.

Feedback is integrated into the model through incremental parameter updates using algorithms such as stochastic gradient descent or reinforcement learning. This allows the system to evolve over time based on real-world user data, improving performance in live deployment without retraining from scratch.

Communication between the client device and backend model is facilitated via secure RESTful API calls, and the system architecture includes caching mechanisms to reduce latency in delivering recommendations.

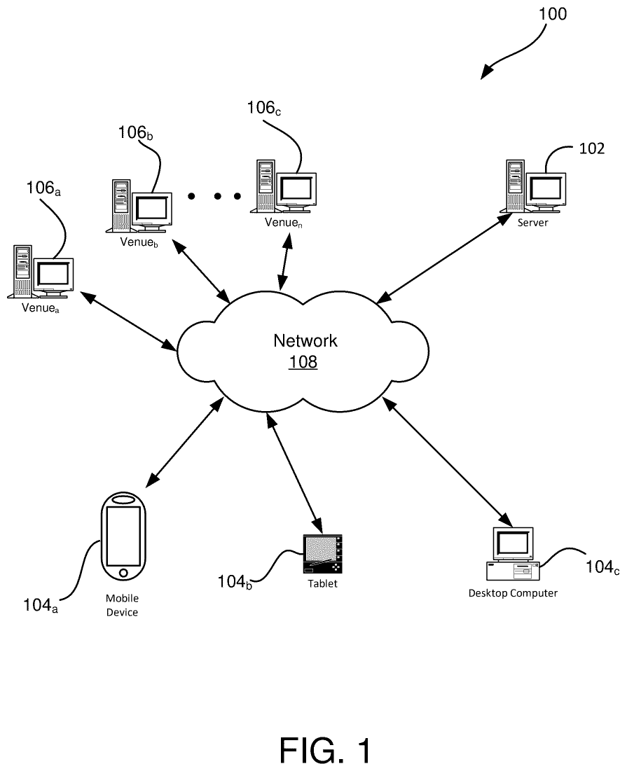

FIG. 1 is a diagram illustrating components of the system 100 of the present disclosure. The system 100 includes at least one server 102 for collecting data, e.g., data related to a venue, feedback data, etc., and processing the collected data to provide recommendations to at least one user of the system 100. Users of the system 100 may access the system 100 via a computing device 104, for example, a mobile device 104a, a tablet 104b, a personal computer 104c, etc. In one embodiment, the user device 104 is a mobile device, such as a mobile phone, that enables a user to enter preferences, receive recommendations and provide feedback, as will be described in more detail below. In one embodiment, the mobile device 104 may include a smartphone, tablet, or wearable device configured to communicate with the server system via a RESTful API. Additionally, the system 100 includes at least one venue computing device 106 configured to provide data related to the venue to the server 102. In one embodiment, the venue computing device 106 may host a website that provides venue data such as location data, opening and closing time data, etc. to the server 102.

The server 102, the at least one user device 104 and the at least one venue computing device 106 may be connected to a communications network 108, e.g., the Internet, by any means, for example, a hardwired or wireless connection, such as dial-up, hardwired, cable, DSL, satellite, cellular, PCS, wireless transmission (e.g., 802.11a/b/g), etc. It is to be appreciated that the network may be a local area network (LAN), wide area network (WAN), the Internet or any network that couples a plurality of computers to enable various modes of communication via network messages. Furthermore, the server 102 will communicate using various protocols such as Transmission Control Protocol/Internet Protocol (TCP/IP), File Transfer Protocol (FTP), Hypertext Transfer Protocol (HTTP), etc. and secure protocols such as Hypertext Transfer Protocol Secure (HTTPS), Internet Protocol Security Protocol (IPSec), Point-to-Point Tunneling Protocol (PPTP), Secure Sockets Layer (SSL) Protocol, etc.

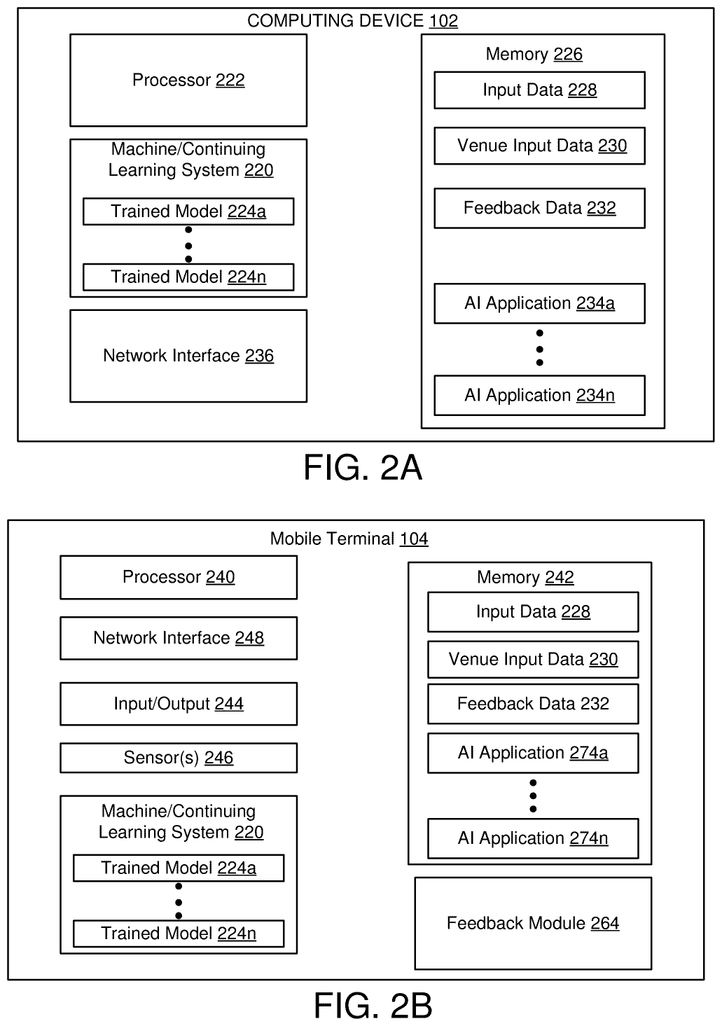

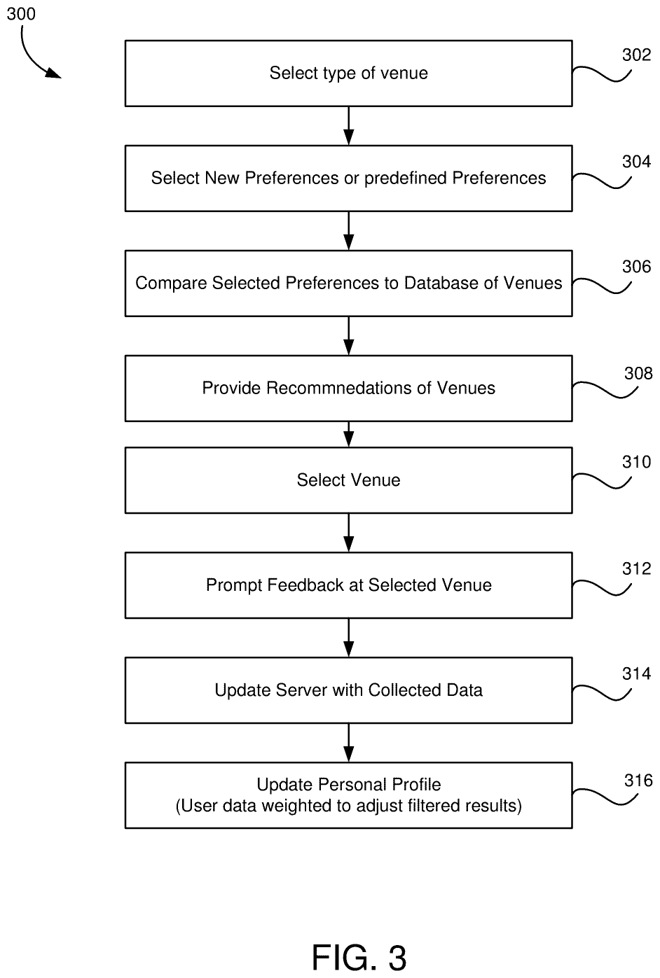

It is to be appreciated that the system 100 of the present disclosure may be implemented in various configurations and still be within the scope of the present disclosure. For example, system 100 may be implemented as machine learning system 220 executing on a server 102 or other compatible device as shown in FIG. 2A and mobile terminal 104 as shown in FIG. 2B. Referring to FIG. 2A, the server 102 may include at least one processor 222 for executing the machine learning system 220 where the machine learning system 220 accesses at least one trained model system 224, e.g., system 224a . . . 224n. The server 102 may further include memory 226 that stores at least the input data 228 (e.g., input data received from mobile terminal 104 of a user to train at least one model), the venue input data 230 (e.g., input data received from the venue computing device 106), and feedback data 232 (e.g., data received from the at least one user and other users of the system 100). Memory 526 may include a plurality of AI applications 234a . . . n, as will be described below. The server 102 further includes a network interface 236 that couples the server 102 to a network 108, such as the Internet, enabling two-way communications to mobile terminals 104 and venue computing devices 106. The mobile terminals 104 may upload feedback data 232 to the server 102 and/or download new or updated AI applications 234a . . . n and models 224a . . . n from the server 102.

Referring to FIG. 2B, user device 104 may include at least one processor 240 for executing at least one AI application 274a . . . n residing on a memory 242 of the mobile terminal 104. In one embodiment, the at least one processor 240 of the mobile terminal 104 may execute the machine learning system 220 to retrain a model locally, fine tune a model locally and/or build an initial model from scratch. Memory 242 may further store at least the user input data 228, e.g., a user profile including selected preferences. The memory 242 may further include feedback data 232 that is provided by the user via their associated mobile terminal 104. The mobile terminal 104 includes an input/output interface 244, e.g., a touchscreen display, that displays data to a user and receives input data from a user. Additionally, the mobile terminal 104 includes at least one sensor 246 and/or sensor interface to capture data. In one embodiment, the at least one sensor 246 may include, but is not limited to, a camera, a microphone, a temperature sensor, an accelerometer and/or a GPS sensor to capture and provide real world data. Alternatively, the at least one sensor 246 may include a sensor interface that couples a sensor externally from the mobile terminal 104.

In one embodiment, user data is stored in the user profile on the user devices 104 and in the user's account on the server 102. This will allow the user to retrieve their data and/or user profile should they lose their device, etc. In another embodiment, user profiles and selected preferences/favorites data are stored in the server 102. In this embodiment, the data is then retrieved and shown in the app on the user device 104, from a server API call. In a further embodiment, all Artificial Intelligence/AI processing will execute on the server 102 and get displayed to the user on their device 104.

The mobile terminal 104 further includes a network interface 248 that couples the mobile terminal 104 to a network 108, such as the Internet, enabling two-way communications to server 102. The mobile terminals 104 may upload feedback data 232 to the server 102 via the network interface 248. A feedback module 264 may prompt a user of the mobile terminal 104 to provide feedback data, for example, an in-person impression of a particular venue, as will be described in more detail below.

In one embodiment, the above-described trained machine learning model may include a neural network or gradient-boosted decision tree trained on historical venue selection data.

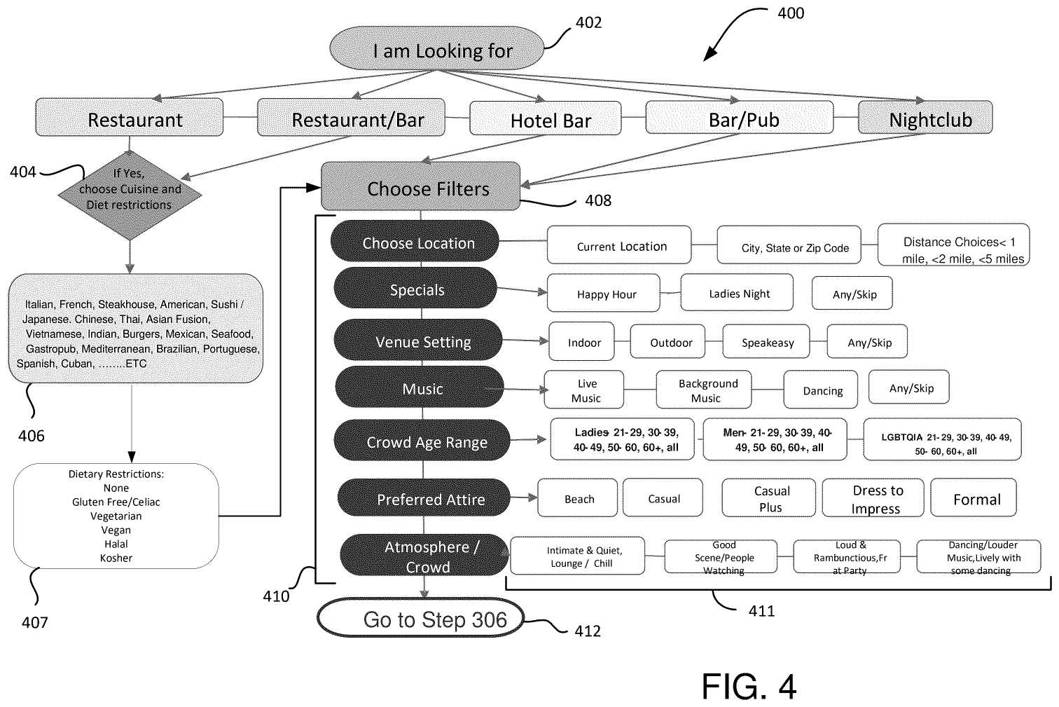

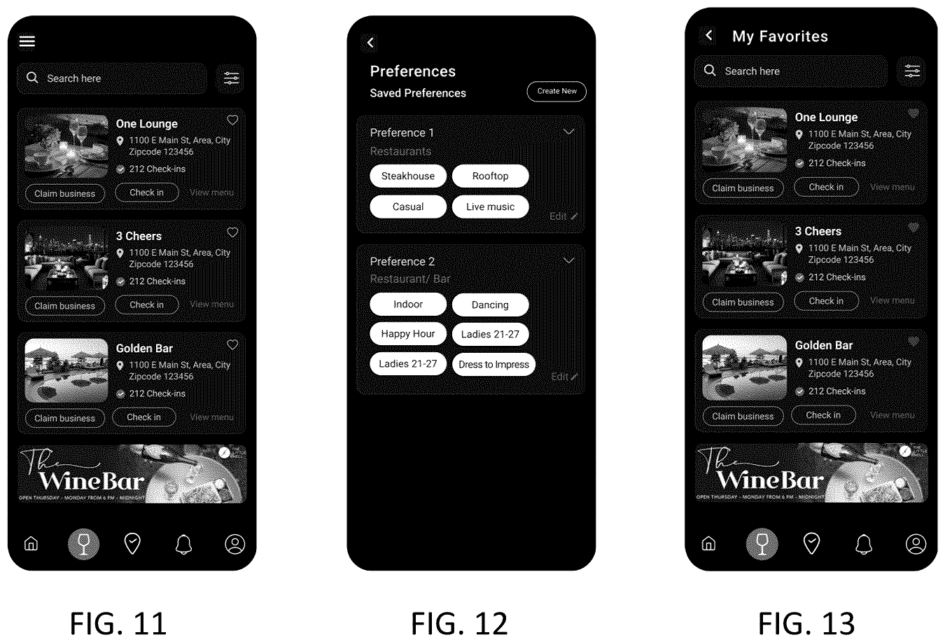

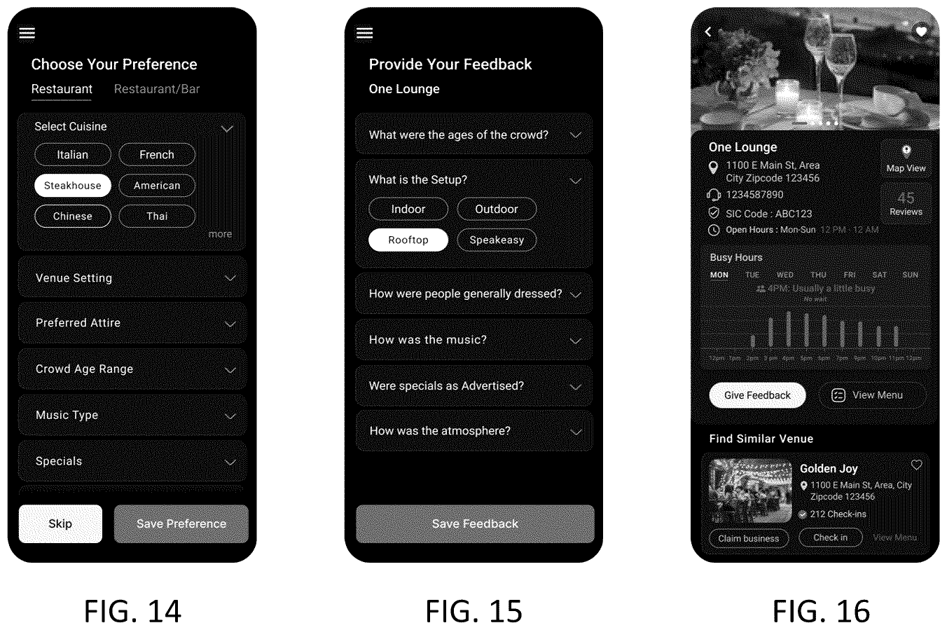

FIG. 3 is a flowchart 300 illustrating overall processing steps carried out by the system 100 of the present disclosure. Beginning in step 302, after an introduction or splash screen as shown in FIG. 8 is presented on the user device 104, a user is prompted to select a type of venue. Referring to FIG. 9, a screen shot of a graphical user interface (GUI) provided on the user device 104 is illustrated, where the user interface prompts the user to select the type of venue, e.g., a restaurant, a restaurant with bar, hotel bar, bar/pub, nightclub, Speakeasy, etc. Next, in step 304, a user is prompted to select their preferences for the type of venue selected via the user interface generated on the user mobile device 104. FIG. 10 illustrates a screenshot of a user interface provided on the user device 104 that enables the user to select their preferences. In one embodiment, as each preference is selected, a menu will present a plurality of options to be selected, as shown in FIG. 14. It is to be appreciated that the preferences selected for the type of venue may be saved for future use, as shown in FIG. 12. It is further to be appreciated that the user preferences may be stored in memory 242 of device 104 and/or in memory 226 of server 102.

In step 306, the entered preferences of the user are compared to a database of venues at the server 102 and, in step 308, the most relevant matched venues are presented to the user on the user device 104, as shown in FIG. 11. In one embodiment, the graphical user interface displays the recommendation using a map interface, ranked list, or interactive suggestion slider. Initially, listings are being pulled into the application on the server 102, for example, via google business listings, by business SIC code, etc., which will enable the server 102 to only pull the information into the application of the types of venues that are determined to be listed. These venues will have some of the data, as an example, it would already have that a place is a restaurant, bar, nightclub, or hotel, by the sic code assigned to those types of businesses. Enhanced data may be supplied by venue owner, venue staff, or end user with their feedback. The venue owner or manager would fill in a weekly calendar grid for all of the filters, and answer some additional questions when registering their business that will all tie into the filters. The users will have the ability to provide feedback on results. As an example, was it ladies' night? Was there live music, was the attire casual, etc. The user can suggest an edit, and the owner will be able to adjust/confirm. If enough users provide the same feedback, then this will change by user demand. The application then uses it's searching & filtering algorithm to identify which venues best match with the user's request.

In step 310, the user selects a venue from the suggested venues. When the user arrives at the selected venue, the user device 104 prompts the user for feedback, in step 312. In one embodiment, the user device 104 automatically prompts for feedback of the selected venue in real-time upon determining that the user device 104 is in the location of the selected venue based on a GPS sensor, e.g., sensor 246, in the user device. As shown in FIG. 15, a feedback screen is automatically generated and presented on the user device 104. In one embodiment, the feedback screen includes selectable options based on the selected venue. In another embodiment, when the user checks into the selected venue, for example, at a kiosk, tablet or other venue computing device 106, an indication from the venue computing device 106 is sent to the server 102 which then forwards the indication to the user device 104, which then prompts the user for feedback in real-time. The user is prompted to verify the filter and/or preference choices made in step 304. In this step, the user is also enabled to mark the selected venue as a favorite, so to be able to easily retrieve at a later time, as shown in FIG. 13. The selected favorite may then be used at a later time, as input to the AI to make a similar recommendation at a different location, e.g., in a different city or state.

In step 314, the collected feedback is sent to the server 102 and stored in memory 226. The collected feedback will be fed to the AI application 234 to update the model 224 to improve the recommendations. Additionally, in step 316, the collected feedback may be used to update the personal profile of the user. Additionally, the users have the ability to provide feedback on results. As an example, was it ladies night? (They can confirm) Was there live music, was the attire casual, etc. The user can suggest an edit, (for example, the restaurant was not Gluten Friendly). If enough users, i.e., an adjustable predetermined number of users, provide the same feedback, and the venue manager does not adjust the settings accordingly, then this will change by user demand. As an example, if enough users are expecting ladies night to be Thursday because of the venue settings, but users consistently provide feedback on Thursdays that it is in fact “not ladies night” the option will be updated “by user demand”, the venue operator will get an alert, and that setting will be locked and if the venue manager wishes to change that, the venue manager will need to request the change.

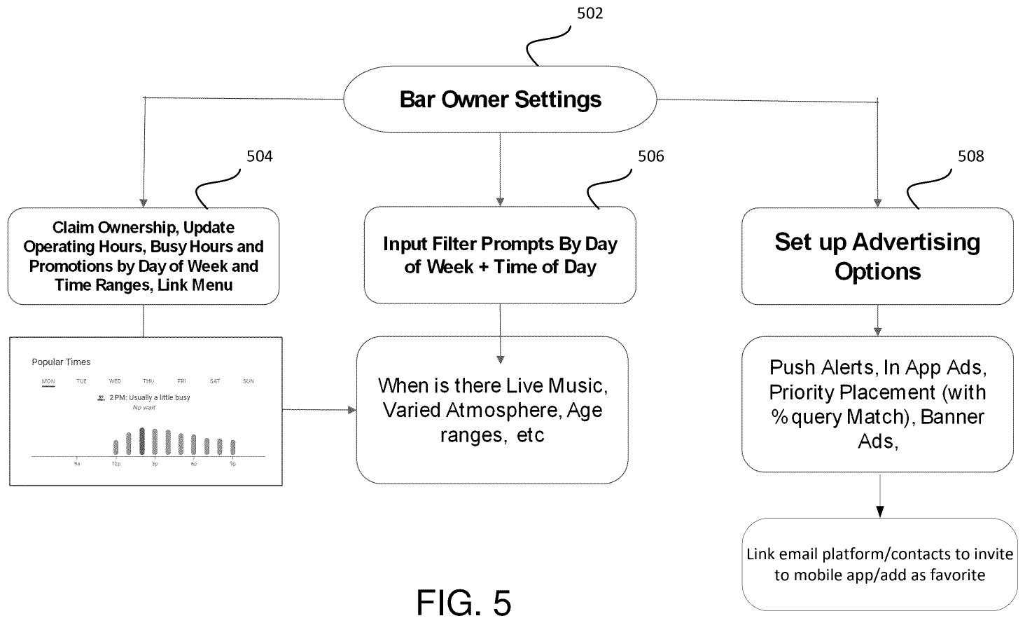

Referring to FIG. 4, a method 400 for selecting user preferences is illustrated. It is to be appreciated that the method 400 corresponds to steps 302 and 304 of FIG. 3. Initially, the mobile device 104 is defaulted to search for recommendations based on a current location of the mobile device, for example, within a two-mile radius. Alternatively, a user interface of the mobile device 104 will prompt the user to select “Use Current Location” or “Location: City, State or Zip Code-Location settings enabled” or Distance Choices <1 mile, <2 mile, <5 miles.

In step 402 (corresponding to step 302 of FIG. 4), the mobile device 104 prompts the user to select a type of venue by displaying “I am Looking for” and providing the options of “Restaurant”, “Restaurant/Bar”, “Hotel Bar”, “Bar/Pub”, Sports Bar, Dive Club, “NightClub”, Adult Cabaret or “Any”. It is to be appreciated that other types of venues are contemplated to be within the scope of the present disclosure. In step 404, if Restaurant is chosen, the user will be prompted to “Choose Cuisine” as shown in FIG. 14, in step 406, for example, Italian, French, Steakhouse, American, Sushi/Japanese. Chinese, Thai, Asian Fusion, Vietnamese, Indian, Burgers, Mexican, Seafood, Gastropub, Mediterranean, Brazilian, Portuguese, Spanish, and Cuban, and so on. The user will also be able to choose dietary Restrictions such as: None, Gluten Free/Celiac, Vegetarian, Vegan, Halal, Kosher, in step 407.

In step 408, the user is then prompted to select various filters 410. Referring to FIG. 10, the various filters 410 are presented to the user. Upon selecting a filter 410, options 411 will be presented to the user for selection, for example:
Specials (select all that apply): Early Bird (discounted menu items) Happy Hour (Discounted drink promotions)/Ladies Night (Ladies Promotion), Trivia Nights/Any/Skip
Venue Setting: Indoor/Outdoor/Speakeasy/Any/Skip
Music (all is default): Live Music/DJ/Karaoke/Background Music/Dancing
Crowd Age range-choose all that apply or select all: Ladies 21-29, 30-39, 40-49, 50-59, 60+, all−/Men 21-29, 30-39, 40-49, 50-60, 60+, all/LGBTQIA: 21-29, 30-39, 40-49, 50-60, 60+, all/Don't Care
Preferred Attire (Select all that apply): Beach/Casual/Casual Plus/Dress to Impress/Jackets & Suits
Attire Defined: Beach-Swimsuits/tank tops/bare feet; Casual-Open toe shoes, sneakers, jeans, caps, T shirts; Casual Plus-More presentable attire, no sneakers, no baseball caps; Dress to Impress-collared shirts, no jeans, jackets optional-Think Country Club; Semi Formal, Jackets & Suits-Sports Jacket at a minimum for the gentlemen. No Jeans
Atmosphere & Crowd: (select all that apply): Intimate & Quiet/Loungy and Chill/Good Scene/People Watching/Dancing/Louder Music/Lively with some dancing/Loud and Rambunctious/Frat Party
   After all the filters are selected, the user may the selected options to “Save Preferences” for future use. The user can label this preference as they wish and save it to their profile. As described above, a user profile may be stored in memory 242 of the user's device 104 or may be stored in memory 226 of server 102. In step 412, the method reverts to step 306 of FIG. 3.

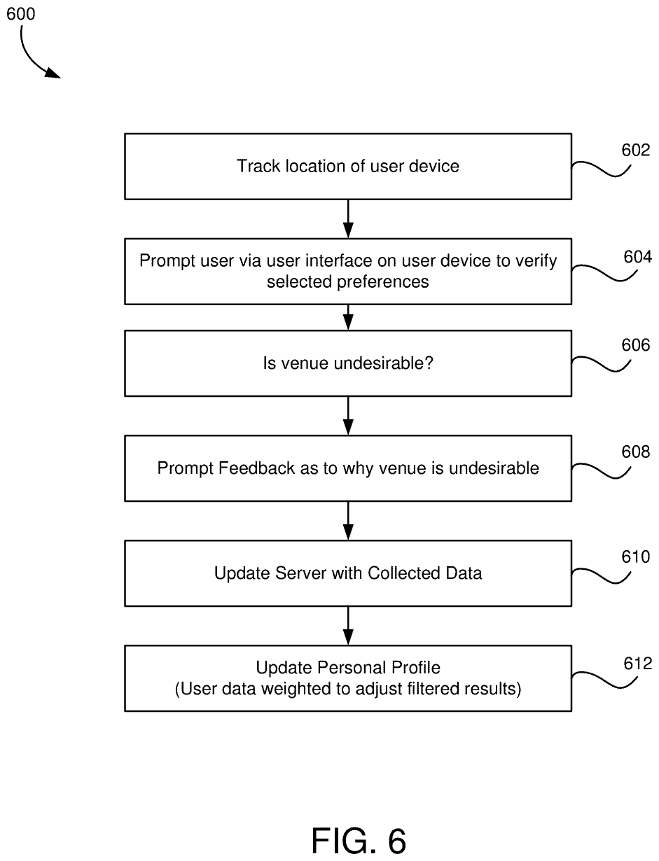

It is to be appreciated that certain data related to a particular venue may be retrieved from various sources via the network 108, e.g., the Internet. In one embodiment, data is pulled from a venue's Google Business Listing, e.g., name of venue, location, phone number, hours, popular or busy hours of operation, etc. Furthermore, an owner of the venue will have the ability to update/input settings related to the venue via the venue computing device 106. In the mobile app, the venue owner will have an option to claim the listing to the venue. Once the venue is claimed, the owner may update/input settings 502 as shown in FIG. 5.

In step 504, the owner may claim the venue-related listings and set up their business profile. For example, the venue owner may:
Claim Location-Verify ownership of listing by Linking their GMB (Google My Business) page to link their profile. Allow app access to profile, link phone, texting (use user's cell phone to text/email)
Claim Location or Add Location if Not there. (Add Location will require approval if no Google Business Listing exists)
Ability to enhance Profile
   a. Add/adjust daily busy times, specials happy hour, when reservations are required
   b. Add/adjust crowd demographics for days/times
   c. Add/Adjust Attire required for certain times/days
   d. Add/Adjust Music Types and Times
   e. Add Adjust Vibe/Atmosphere by Day and Time of Day

Once the venue owner claims ownership, the mobile app will enable input filter prompts by day of week and time of day for the venue, in step 506. For example, a weekly calendar may be provided to fill in an average week so the venue can set days of week and times of day that the venue is open, has any specials, has live music, DJ, Karaoke, when the attire or atmosphere may be different. The venue can answer questions on cuisine, and dietary restrictions. They can enter when the venue is more lively, or when it is more laid back, and so on.

In step 508, the venue owner may set up an advertising account to promote the venue, specials, a special event, etc. and link it to a specific location. Additionally, the venue owner may set up various types of advertising, e.g., Push Alerts, Texts and In App Banners. For example, a Push Alert could be a bar owner looking to ping all the phones with app downloaded to promote a happy hour, or whatever. Additionally, the mobile app may integrate with reservation systems for people to see/request reservations through the app. Furthermore, an email platform and/or contact lists of the venue owner (e.g., residing on venue computing device 106) may be linked to the system server 102 so the system server 102 may generate invites to join the mobile app, e.g., either via an email or text invite.

It is to be appreciated that once a certain volume of feedback is collected for a claimed venue, meaning the owner has access to their business listing and set up all their filters by day of week and time, this data will be weighted along with the owner's settings. The users will have the ability to provide feedback on results. As an example, was it ladies night? (The users can confirm) Was there live music, was the attire casual, etc. The user can suggest an edit, (e.g., the restaurant was not Gluten Friendly). If enough users, i.e., an adjustable predetermined number of users, provide the same feedback, and the venue manager does not adjust the settings accordingly, then this will change by user demand. As an example, if enough users are expecting ladies night to be Thursday because of the venue settings, but users consistently provide feedback on Thursdays that it is in fact “not ladies night” the option will be updated “by user demand”, the venue operator will get an alert, and that setting will be locked and if the venue manager wishes to change that, they will need to request a change.

The owner will also see the venue data and may want to adjust their settings if need be to make it even more accurate to the user. For non-claimed venues, user feedback will be weighted with greater influence, until such a time as an owner claims this listing.

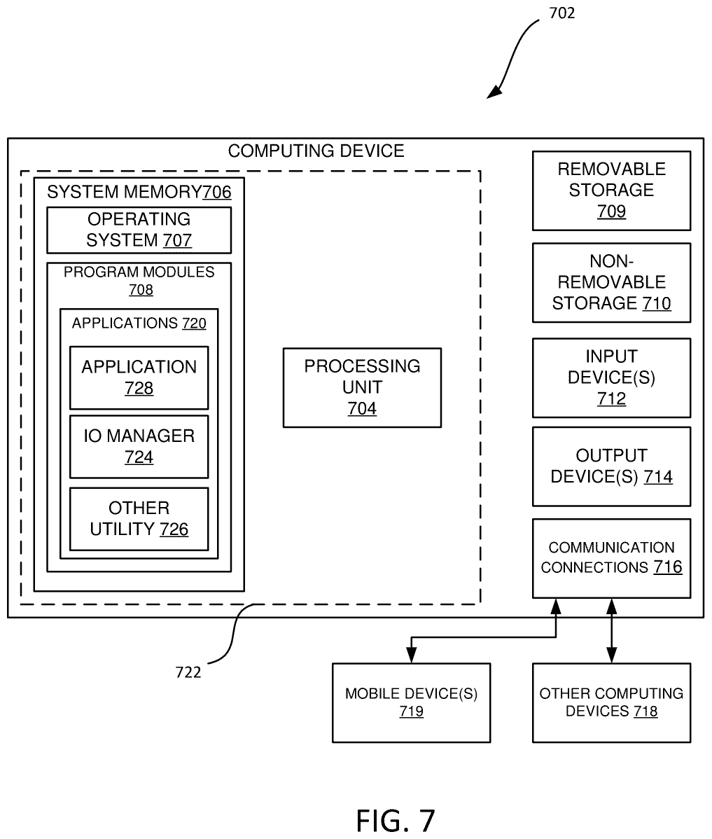

Referring to FIG. 6, a method 600 for collecting crowd-sourced feedback is illustrated. In step 602, a location of a user device 104 is tracked. In step 604, when the user device 104 detects that the user device 104 is at the selected venue, the user device 104 prompts the user to provide feedback in real-time verifying the selected preferences, for example, as shown in FIG. 15. Next, in step 606, the user device 104 enables the user to label venues “Undesirable” within their profile, and prevent similar locations from showing. In step 608, the user device 104 will prompt questions as to why the user has indicated that the venue is undesirable, e.g., having to do with the sorting or the experience was different. In step 610, the feedback will be sent to the server 102 and the customer feedback will be factored into the results of the baseline settings that business owners will be defining when verifying their listings. Lastly, in step 612, the user's profile will be updated. Additionally, the customer feedback is stored as feedback data 232 in memory 226 on server 102, where the feedback data 232 is fed to at least one AI application 234 to improve future recommendations of venues. In other embodiment, a user may voluntarily provide feedback while at a particular venue. For example, while reviewing the details of a particular venue, as shown in FIG. 16, a user may select “Give Feedback” option on the screen of the user device 104 to provide feedback.

It is to be appreciated that the server system stores user preference profiles and adapts future recommendations based on a combination of individual and aggregate usage data. It is further to be appreciated that the feedback is used to adjust model weights in real-time using a learning algorithm.

It is to be appreciated that the crowd-sourced feedback is not only from the users that have selected a venue and subsequently visited that venue but also from users that make unscheduled visits to venues. For example, a user with a user device 104 visits a venue that is in the database of the system, i.e., the venue is participating in the system of the present disclosure. When user device 104 detects that the user is in a participating venue, the method of FIG. 6 will trigger and prompt the user for feedback in real-time.

It is further to be appreciated that the crowd-sourced feedback may be a verification of expectations and/or allowing the user to make suggested adjustments to inaccurate information. By using the mobile device 104, users will verify or suggest adjustments to the segmented items, e.g., Atmosphere, Music, Specials, Crowd Age, Promos, attire, etc.

It is to be appreciated that the AI is a “reactive AI” in that it is task specific. Users can fill in all the parameters they like and save that as a “preferred profile” or they can mark bars, restaurants that they already like and know as one of their “favorites”, as shown in FIG. 13. In either of those cases, the system of the present disclosure will be able to make suggestions to the user to match their favorites in other locations around the world. However, unlike reactive machines, the system and method will get smarter or better as users share data from their experiences. The app can look into the past and monitor specific ratings, and inputs over time. Then, these observations are programmed into the AI so that its actions can be performed based on both past and present moment data. But in limited memory, this data isn't saved into the AI's memory as experience to learn from, the way humans might derive meaning from their successes and failures. The AI improves over time as it's trained on more data.

The devices and methods of the present disclosure may utilize places marked as a “Favorite” by the user and, when the user (or user device 104) is in other areas (e.g., in another city, state, country, etc.), will find something similar to the user's favorites, or find a match to one of their preferences. For example, when in other cities or areas, user device 104 may determine the user's location via a GPS sensor, e.g., sensor 246 . . . Processor 240 of user device 104 may then retrieved the user's saved preferences/favorites from memory 242 to find similar types of places and to recommend places based on the user's determined location. The processor 240 of user device 104 will interact with the AI functionality (e.g., via either AI applications 274 in user device 104 or AI applications 234 in server 102) to make suggestions of similar places based on the user's saved preferences and favorites. In another embodiment, the user may select a previously stored favorite venue from “My Favorites” as shown in FIG. 13. The AI functionality will then generate recommendations based on a location of the user device 104 (as determined by sensor 246) and the selected favorite.

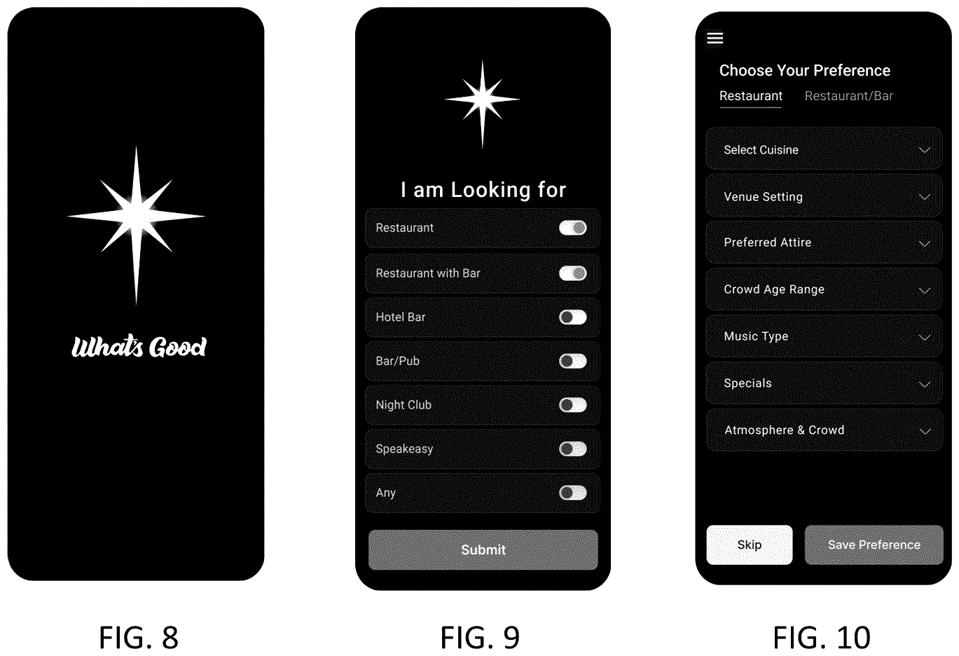

FIG. 7 is a diagram showing hardware and software components of a computing device 700 on which an embodiment of the system of the present disclosure can be implemented. It is to be appreciated the components of device 700 may be embodied in the server 102 of FIG. 2A and/or mobile terminal 104 of FIG. 2B. Among other examples, computing device 700 may be an exemplary computing device configured for execution of a crowd-sourced recommendation system as described herein. In a basic configuration, the computing device 700 may include at least one processing unit 704 and a system memory 706. Depending on the configuration and type of computing device, the system memory 706 may comprise, but is not limited to, volatile storage (e.g., random access memory), non-volatile storage (e.g., read-only memory), flash memory, or any combination of such memories. The system memory 706 may include an operating system 707 and one or more program modules 708 suitable for running software programs/modules 720 such as IO manager 724, other utility 726 and application 728. As examples, system memory 706 may store instructions for execution. Other examples of system memory 706 may store data associated with applications. The operating system 707, for example, may be suitable for controlling the operation of the computing device 702. Furthermore, examples of the present disclosure may be practiced in conjunction with a graphics library, other operating systems, or any other application program and is not limited to any particular application or system. This basic configuration is illustrated in FIG. 7 by those components within a dashed line 722. The computing device 702 may have additional features or functionality. For example, the computing device 702 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 706. While executing on the processing unit 704, program modules 708 (e.g., Input/Output (I/O) manager 724, other utility 726 and application 728) may perform processes including, but not limited to, one or more of the stages of the operations described throughout this disclosure. Other program modules that may be used in accordance with examples of the present disclosure may include electronic mail and contacts applications, word processing applications, spreadsheet applications, database applications, slide presentation applications, drawing or computer-aided application programs, photo editing applications, authoring applications, etc.

Furthermore, examples of the present disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 702 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the present disclosure may be practiced within a general-purpose computer or in any other circuits or systems.

The computing device 702 may also have one or more input device(s) 712 such as a keyboard, a mouse, a pen, a sound input device, a device for voice input/recognition, a touch input device, etc. The output device(s) 714 such as a display, speakers, a printer, etc. may also be included. The aforementioned devices are examples and others may be used. The computing device 704 may include one or more communication connections 716 allowing communications with other computing devices 718 and/or mobile devices 719. Examples of suitable communication connections 716 include, but are not limited to, a network interface card; RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 706, the removable storage device 709, and the non-removable storage device 710 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 702. Any such computer storage media may be part of the computing device 702. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is to be appreciated that the computing device 720 may, in certain embodiments, be a mobile computing device, for example, a mobile telephone, a smart phone, a wearable device such as a smartwatch, a personal data assistant, a tablet personal computer, a phablet, a slate, a laptop computer, and the like, with which examples of the present disclosure may be practiced.

A system and method for generating venue recommendations based on user preferences and adaptive feedback using machine learning are provided. A user interacts with a mobile device to select a venue type and input preferences via a graphical user interface (GUI). These inputs are transmitted to a server system, which generates one or more venue recommendations using a trained machine learning model. The recommendation is returned to the mobile device, and user feedback is collected in response. The feedback is used to incrementally update the model, improving recommendation accuracy over time. The system operates in a distributed environment and leverages real-time learning techniques to dynamically adapt to evolving user behavior without requiring full retraining. The present disclosure enables more responsive, accurate, and personalized venue recommendations across devices.

It is to be appreciated that the various features shown and described are interchangeable, that is a feature shown in one embodiment may be incorporated into another embodiment. It is further to be appreciated that the methods, functions, algorithms, etc. described above may be implemented by any single device and/or combinations of devices forming a system, including but not limited to mobile terminals, servers, storage devices, processors, memories, FPGAs, DSPs, etc.

While the disclosure has been shown and described with reference to certain preferred embodiments thereof, it will be understood by those skilled in the art that various changes in form and detail may be made therein without departing from the spirit and scope of the disclosure as defined by the appended claims.

Furthermore, although the foregoing text sets forth a detailed description of numerous embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

What is claimed is:

1. A computer-implemented method for recommending a venue to a user comprising:
executing, by a processor of a computing device, instructions stored in a non-transitory computer-readable medium, wherein the instructions cause the computing device to perform:
receiving, via a graphical user interface (GUI) of a venue recommendation application, a user input indicating a type of venue selection;
receiving at least one user preference related to the selected type of venue;
providing, using a trained machine learning model executed by the processor, at least one recommendation of a venue based on the selected type of venue and the user preference;
receiving, through the GUI, user feedback on the recommendation; and updating the machine learning model using the feedback via an incremental learning algorithm to improve accuracy of future venue recommendations,
wherein the model is configured to dynamically adapt to evolving user preferences over time, and the method is implemented within a networked computing environment comprising a mobile device and a server system.

2. The method of claim 1, wherein the receiving feedback includes receiving crowd-sourced feedback from a plurality of users.

3. The method of claim 2, wherein the receiving feedback includes prompting a user for the feedback when at the recommended venue.

4. The method of claim 2, wherein the receiving feedback includes determining that the user is located at the recommended venue and prompting the user for the feedback in real-time when at the recommended venue.

5. The method of claim 4, further comprising prompting at least one second user for feedback when the at least one second user is at a predetermined venue.

6. The method of claim 5, wherein the prompting is generated on a user interface of a mobile device.

7. The method of claim 1, wherein the type of venue includes at least one of a restaurant, a bar, a pub, a night club, and/or an adult cabaret.

8. The method of claim 1, further comprising:
storing, in a memory, the received at least one user preference;
determining, via a sensor, a location of the user; and
providing, using the trained machine learning model executed by the processor, at least one second recommendation of a venue based on the stored user preference and determined location.

9. A user interface for recommending a venue to a user comprising:
means for receiving a type of venue selection;
means for receiving at least one preference related to the selected type of venue;
means for providing, via an artificial intelligence model, at least one recommendation of a venue based on the selected type of venue and preference;
means for receiving feedback on the selected preferences of the recommended venue; and
means for providing the feedback to the artificial intelligence model to improve an accuracy of a subsequent recommendation.

10. The user interface of claim 9, further comprising means for determining that the user is located at the recommended venue and means for prompting the user for the feedback in real-time when at the recommended venue.

11. The user interface of claim 10, wherein the type of venue includes at least one of a restaurant, a bar, a pub, a night club, and/or an adult cabaret.

12. The user interface of claim 11, wherein the at least one preference related to the selected type of venue includes a location, specials offered, venue setting, music played at venue, crowd age range, preferred attire and/or atmosphere.

13. A system for recommending a venue to a user comprising:
at least one processing device;
a non-transitory computer-readable medium storing instructions that, when executed by the at least one processing device, cause the system to:
receiving, over a network, from a mobile device, a user input indicating a selection of a type of venue via a graphical user interface (GUI);
receiving, from the mobile device, at least one user preference associated with the selected type of venue;
generating, using a trained machine learning model executed by the at least one processing device, at least one venue recommendation based on the selected type of venue and the user preference;
transmitting the at least one venue recommendation to the mobile device for display on the GUI;
receiving, from the mobile device, feedback related to the recommended venue; and
updating the machine learning model using the feedback via an incremental learning algorithm to improve accuracy of future venue recommendations,
wherein the system is configured to operate in a distributed computing environment including the mobile device and a server system, and the machine learning model is dynamically updated without requiring retraining.

14. The system of claim 13, further comprising a plurality of mobile devices, wherein each mobile device provides feedback to create crowd-sourced feedback.

15. The system of claim 13, wherein the mobile device includes means for determining that the user is located at the recommended venue and means for prompting the user for the feedback in real-time when at the recommended venue.

16. The system of claim 13, wherein the trained machine learning model comprises a neural network or gradient-boosted decision tree trained on historical venue selection data.

17. The system of claim 13, wherein the feedback is used to adjust model weights in real-time using a learning algorithm.

18. The system of claim 13, wherein the mobile device comprises a smartphone, tablet, or wearable device configured to communicate with the server system via a RESTful API.

19. The system of claim 13, wherein the server system stores user preference profiles and adapts future recommendations based on a combination of individual and aggregate usage data.

20. The system of claim 13, further comprising a memory that stores received at least one user preference; wherein the at least one processing device provides, using the trained machine learning model, at least one second recommendation of a venue based on the stored user preference and a determined location of the mobile device.
